(19) United States
(12) Patent Application Publication
(10) Pub. No.: US 2011/0173596 A1
(43) Pub. Date: Jul. 14, 2011

(54) METHOD FOR FACILITATING COMPILATION OF HIGH-LEVEL CODE FOR VARYING ARCHITECTURES

(76) Inventor: Martin Vorbach, Lingenfeld (DE)

(21) Appl. No.: 12/745,335

(22) PCT Filed: Nov. 28, 2008
(86) PCT No.: PCT/DE08/01971

§ 371 Date: Mar. 24, 2011

(30) Foreign Application Priority Data
Nov. 28, 2007 (DE) 10 2007 057 642.2

(51) Int. Cl. G06F 9/45

(52) U.S. Cl. 717/146

(57) ABSTRACT

The invention relates to a method for compiling high-level language code for various architectures and/or components. The invention proposes that an architecture-specific precompilation be generated and subsequently the architecture-specific precompilation be compiled taking into account component-specific information.

### CROSS-REFERENCES TO RELATED APPLICATIONS

This application is the National Stage of International Application No. PCT/DE2008/001971, filed Nov. 28, 2008, which claims priority to German Patent Application No. DE 10 2007 057 642.2, filed Nov. 28, 2007, the entire contents of each of which are expressly incorporated herein by reference.

### FIELD OF THE INVENTION

The present invention relates to how an executable machine code may be generated for a given higher-language program considering that, possibly because of a processor change, for example the utilization of newer processor generations, a change in the machine code may become necessary.

### BACKGROUND OF THE INVENTION

In the context of the execution of programs on data processing installations, such as laptops, servers and such, a plurality of files, which are executable, may typically be kept available with the system, meaning for example on the hard drive of a laptop or on the hard drive array of a server. In order for a user to be able to start a single program, typically a plurality of module-like interacting, executable parts may be required. In conventional operating systems such as MICROSOFT WINDOWS, these program parts may feature endings such as “.exe” and “.dll”.

During the processing of a program, a plurality of different modules, which are executable, may be frequently called. These executable modules together may form a library.

The individual elements of a library may be in that context adapted for the execution to the respective data processing architecture. This adaptation may typically be implemented through the compilation of a program part or program written in a higher programming language. During the compilation, a plurality of conversions of the higher-language program or program part may be performed in order to arrive at a code section that is executable on the target architecture. The compilation may be a very well established process in the technology. One refers in particular to standard textbooks such as WIRTH, Compilerbau, AHO, SETHI and ULLMANN “Red Dragon.”

With conventional compilers the high-language source text may be initially parsed into sections, so-called “symbols” or instructions, that may be suitable for compilation, searched in regard to syntax errors, etc. This may occur in the so-called front end of the compiler. The processed code that is received from the front end may then be abstracted in order to obtain a so-called RTL code (Register Transfer Level-Code). At this stage the data flow and control flow graphs may typically already be available that, for example, find mention also in the publications of the applicant (PCT/DE02/03278, PCT/EP02/10065, PCT/EP04/009640, PCT/EP03/00624), including all family members. The named publications are, for the purpose of disclosure, incorporated herein by reference in their entirety.

### BRIEF SUMMARY OF THE INVENTION

Target architectures of the compiler may be reconfigurable architectures.

What is understood to be a reconfigurable architecture, and such, may be components (VPU) that feature a plurality of elements (PAE) that may be modified in function and/or networking during operation and which may preferably be disposed in a two- or higher-dimensional matrix. Part of the elements may be arithmetic logic units, FPGA areas, input/output cells, memory cells, analog components, etc. These may usually be coarse-granular, consequently for example at least 4 bits, preferably 8 bits, wide and configurable in their function and networking. In between fine-granular areas may however also be disposed. Components of this kind may for example be those known under the label VPU. This encompasses what may typically be called PAEs, such as one- or more-dimensionally disposed arithmetic, logic, analog, storing, networked, and/or communicating peripheral components (IO) that may be connected to one another either directly or through one or several bus systems. The PAEs may be arranged in any implementation, mixture and hierarchy, whereby the arrangement may be called PAE-Array (PA). Associated with the PAE Array may be a configuration unit. In principle, besides VPU components, systolic arrays, neuronal networks, multi-processor systems, processors with several computational cores and/or logic cells, networking and network components such as crossbar-circuits, etc. may be those known, as is the case with FPGAs, DPGAs, transputer, etc.

In particular FPGAs may belong to the target architectures, whereby the FPGAs features preferably at least some of the previously listed (usually coarse-granular configurable) elements (PAEs). Particularly preferred may be at least a row or column within the FPGA architecture that features elements with at least an adder and a multiplier, or an arithmetic-logic unit (ALU).

Apart from that, one refers, regarding the target architectures and advantageous data processing procedures on these target architectures, to the following documents of the applicant: P 44 16 881.0-53, German Patent Application No. DE 197 81 412.3, German Patent Application No. DE 197 81 483.2, German Patent Application No. DE 196 54 846.2-53, German Patent Application No. DE 196 54 593.5-53, German Patent Application No. DE 197 04 044.6-53, German Patent Application No. DE 198 80 129.7, German Patent Application No. DE 198 61 088.2-53, German Patent Application No. DE 199 80 312.9, International Patent Application No. PCT/DE00/01869, German Patent Application No. DE 100 36 627.9-33, German Patent Application No. DE 100 28 397.7, German Patent Application No. DE 101 10 530.4, German Patent Application No. DE 101 11 014.6, International Patent Application No. PCT/EP00/10516, European Patent Application No. EP 01 102 674.7, International Patent Application No. PCT/DE97/02949, International Patent Application No. PCT/DE97/02998, International Patent Application No. PCT/DE97/02999, International Patent Application No. PCT/DE98/00334, International Patent Application No. PCT/DE99/00504, International Patent Application No. PCT/DE99/00505, German Patent Application No. DE 101 39 170.6, German Patent Application No. DE 101 42 903.7, German Patent Application No. DE 101 44 732.9, German Patent Application No. DE 101 45 792.8, German Patent Application No. DE 101 54 260.7, German Patent Application No. DE 102 07 225.6, International Patent Application No. PCT/DE00/01869, German Patent Application No. DE 101 42 904.5, German Patent Application No. DE 101 44 733.7, German Patent Application No. DE 101 54 259.3, German Patent Application No. DE 102 07 226.4, German Patent Application No. DE 101 10 530.4, German Patent Application No. DE 101 11 014.6, German Patent Application No. DE 101 46 132.1, German Patent Application No. DE 102 02 044.2, German Patent Application No. DE 102 02 175.9, German Patent Application No. DE 101 35 210.7, International Patent Application No. PCT/EP02/02402, European Patent Application No. EP 01 129 923.7, International Patent Application No. PCT/EP03/00624, International Patent Application No. PCT/EP02/10084, International Patent Application No. PCT/DE03/00942, International Patent Application No. PCT/EP03/08080, International Patent Application No. PCT/EP02/10464, International Patent Application No. PCT/EP02/10536, International Patent Application No. PCT/EP02/10572, International Patent Application No. PCT/EP02/10479, International Patent Application No. PCT/EP03/08081, International Patent Application No. PCT/EP03/09956, International Patent Application No. PCT/EP03/09957, German Patent Application No. DE 102 36 269.6, German Patent Application No. DE 102 43 322, European Patent Application No. EP 02 022 692.4, German Patent Application No. DE 103 00 380.0-53, German Patent Application No. DE 103 10 195.0-53, European Patent Application No. EP 03 009 906.3, International Patent Application No. PCT/EP04/006547, European Patent Application No. EP 03 015 015.5, International Patent Application No. PCT/EP04/009640, German Patent Application No. DE 103 41 051.1, International Patent Application No. PCT/EP04/003603, European Patent Application No. EP 03 025 911.3, German Patent Application No. DE 103 57 284.8-55, International Patent Application No. PCT/EP05/001211, German Patent Application No. DE 10 2004 004 955.6, German Patent Application No. DE 04 002 719.5, German Patent Application No. DE 04 075 382.4, European Patent Application No. EP 04 003 258.3, European Patent Application No. EP 04 004 885.2, European Patent Application No. EP 04 075 654.6, European Patent Application No. EP 04 005 403.3, European Patent Application No. EP 04 075 707.2, European Patent Application No. EP 04 013 557.6, European Patent Application No. EP 04 018 267.7, European Patent Application No. EP 04 077 206.3, International Patent Application No. PCT/EP06/001014, European Patent Application No. EP 05 003 174.9, European Patent Application No. EP 05 017 798.9, European Patent Application No. EP 05 017 844.1, European Patent Application No. EP 05 027 332.5, European Patent Application No. EP 05 027 333.3, International Patent Application No. PCT/EP07/000,380, German Patent Application No. DE 10 2007 054 903.4, and German Patent Application No. DE 10 2007 055 131.4, respectively, including all family members.

These references are, for the purposes of disclosure, incorporated herein by reference in their entirety without being restricted here to the particular cases presented or mentioned in the publications.

It should be pointed out that, besides the known XPP components of the application, also other parallel data processing architectures may be considered as the target architectures of the present invention, such as the already known FPGAs. For example, the VIRTEX components of the company XILINX (SPARTAN, VIRTEX-2, VIRTEX-II Pro, VIRTEX-4, VIRTEX-5), etc., or components by Altera, for example STRATIX, etc., should be mentioned. The components feature PAE elements in the form of DSP cells. For a better understanding, one may refer to the data sheets of the corresponding components, which are publicly available, for example, may be obtained via the internet pages of the manufacturers XILINX and ALTERA, and are, for purposes of disclosure, incorporated herein by reference in their entirety.

In addition, multi-thread systems and processors, such as for example INTEL Pentium and XEON or AMD Athlon, may be part of the target architectures.

For a better understanding, one may refer here also to the data sheets of the corresponding components, which are publicly available, for example, may be obtained via the internet pages of the manufacturers INTEL and AMD, and are, for purposes of disclosure, incorporated herein by reference in their entirety.

In conventional compiler construction, the RTL-code, which may already be optimized, may then be further translated in a so-called Backend into the code that can be understood by the respective “machine,” meaning the actual target structure. In the case of re-configurable architectures, the function of the Backend may encompass typically the generation of actually executable configurations from the data flow and control flow graphs that were optimized for this purpose, which may require for example the performance of placing and routing. The relevant prior art, for example, PCT/DE02/03278 of the applicant, was already referred to herein. Other methods may likewise be useable with the present invention.

It may now be problematic that the Backend, which distributes the program or library parts that are adapted to the machine, may have to be very tightly adapted to the respective computer architecture or machine. This typically prevents that the library parts that were generated for a particular target architecture may be executed on a different target architecture or, as far as this could even be the case, execute performance-oriented.

In view of the significant progress in the hardware area that occurs regularly, it may, however, be necessary to provide the end user the opportunity to run his previously executable programs also on improved hardware. This should occur with the least effort, which may typically mean that a compilation of the high-level language code cannot be implemented because such a compilation may be managed, by average or DAU users, only subject to significant difficulties, if at all.

It may be desirable to provide libraries that are machine-adapted.

According to a first exemplary embodiment of the present invention, it is therefore proposed to provide the user a precompilation in which certain optimizations have already been implemented in order to generate, as such a precompilation, an intermediate format that prior to (first) implementation may be ready to be compiled without problems.

The compilation may encompass certain architecture—but not component-specific optimizations of a high-level language code, for example, for the precompilation generation, those optimizations that are mentioned in PCT/EP02/10065, PCT/EP2004/003603, PCT/EP2004/009640, and PCT/EP02/06865. Therefore, for example, optimizations may be implemented that concern the distribution into parallel and vector/sequential program sections or flow parts, or concern a (hyper-) threading, etc. These optimizations may, as the case may be, be supported manually by a programmer; this is however not cogently required. It should be mentioned that, as the case may be, if not in the optimal case, also programs, program parts and modules, meaning existing binaries that are executable on sequentially known processors, may be used as starting code for a precompilation, said programs may be subjected to an architecture-specific analysis, such as to determine parallel components and to facilitate an adaption to parallel architectures even without knowledge of the source code, which may be of an advantage for so-called legacy-code and its application. That it may apply primarily to binaries that can be executed on sequential architectures should be mentioned. It should be mentioned that it may be possible to make certain optimizations for the precompilation generation in such a manner that an adaptation follows also in regard to component characteristics that may generally be expected, for example, by means of adaptation to the number of sequential units that might possibly be expected, such as functions- and/or graphing fold elements in an array. In this case the—typically iteratively—determined object code may admittedly already be optimized in reference to the target components; often however such optimizations remain useful in the context of generation changes.

The precompilation may then be subjected to a component-specific optimization as an object code prior to execution. This component-specific optimization may, for example, be adapted to the breadth and number of available busses, depths of registers and/or locally available storage, the command set of elements such as ALUs in an array, or the different command sets of different elements in an array; during the course of the (second) optimization, temporal partitionings may be implemented corresponding to PCT/EP03/00624. The correspondingly further optimized parts of the RTL may be submitted to a backend and a binary code may be determined therefrom. This may be advantageous for the reason that during change-overs of the actually executing components, for example during the switch from one processor generation to another processor generation, slight adaptations may be implemented through simple postcompilation of the precompilation.

This may be of interest particularly in the case of those target architectures whose hardware architecture cannot be completely abstracted from the executable binary code (executable)—or for reasons of complexity and/or costs should not be. This group may therefore encompass primarily the previously mentioned Field-Programmable-Gate-Arrays (FPGAs) and re-configurable processors, such as for example the VPUs of the applicant, components of the manufacturer SiliconHive (Netherlands), the ADRES architecture of IMEC (Belgium) and IPFlex (Japan). The architecture details may be publicly accessible, and one is referred to the websites and patent applications of the respective providers which, for purposes of disclosure, are fully incorporated herein by reference in their entirety.

It may also be possible to have the binaries that may typically be part of a library for different processors or processor combinations in store, which may make it possible to continue working without the entire operation being affected in the event of a failure of parts of processors. This contributes to a system with a high failure safety. The component-specific data, such as bus widths, field sizes, command sets, etc. may be provided to the post-compiler of the present invention by different means. In the particularly preferred exemplary embodiment, they may be read out of each relevant chip that may be available in the system. In this way, corresponding data may be stored in a ROM or in a flash memory with or on the processor or module. Analogously a storage in a BIOS or similar object may be possible even if it is not preferred.

It may be also possible, particularly if the system has connection to the internet or other data sources, to receive the relevant chip or module data, which may be necessary for compilation, externally.

The present invention therefore may provide a system and/or method for the provision of more flexible and processor-independent code for the end user, as follows:

1. A precompilation may be generated at the software manufacturer by means of a compiler. The precompilation is not a processor-specific binary code in the conventional sense but an intermediate format of the code, for example in the form of graphs or a register transfer language (RTL). The code may preferably feature no machine-specific parts but may instead be a pure processor-independent intermediate format.
2. This precompilation may be provided to the user instead of the usual executable in binary format.
3. The precompilation may be translated on the processor system or computer of the user by means of a post-compiler into the implementable executable in binary format. Different times may be suitable for code translation and may be selected based on system-, market-, and user-specific considerations.

The precompilation may for example be translated at the following times:

a. during the installation of the software,
b. during the loading of the software,
c. during the booting of the computer, and
d. during the execution, whereby even here the interpretation of the precompilation may suggest itself.

At this point the programming language JAVA should be referred to. JAVA is also not distributed as executable binary code (executable) but in the form of an intermediate representation. This is, however, as a significant difference to the present invention, already processor-specific translated for the JAVA Virtual Machine and therefore no longer completely target system-independent. While the code can admittedly be implemented on different target processors, they implement or emulate, however, either within an interpreter at runtime, or by means of a compiler, the JAVA Virtual Machine. All specific limitations of the JAVA Virtual Machine are therefore already implicitly contained in the precompilation and are either barely or no longer optimizable on the target system. This is furthermore one of the primary disadvantages of JAVA because the possible performance is hereby significantly reduced.

In contrast to JAVA, the precompilation according to the present invention may be a pure intermediate format that features no processor- or architecture-specific characteristics and may thereby be efficiently compiled on any possible target system.

The precompilation may thereby however already be preferably optimized and implemented in regard to certain processor types and base architectures. A precompilation for FPGAs may for example already have undergone other optimization steps and transformations in the pre-compiler than the precompilation for conventional sequential processors. The precompilation may also already feature manufacturer-specific optimizations, and the precompilation may distinguish itself in architecture details between, for example, Altera and XILINX FPGAs. The compiler may however be completely independent of certain components within a certain component- or architecture family (for example, Virtex-4) and may be non-preferential in the broadest sense between similar component- or architecture families (such as, for example, Virtex-4 and Virtex-5) and thereby may make possible a flexible and efficient end-compilation in regard to the corresponding target components or target processors.

### BRIEF DESCRIPTION OF THE DRAWINGS

FIG. 1 shows an exemplary embodiment according to the present invention.

FIG. 2a shows a conventional compiler layout.

FIG. 2b shows an exemplary embodiment of a compiler layout according to the present invention.

### DETAILED DESCRIPTION

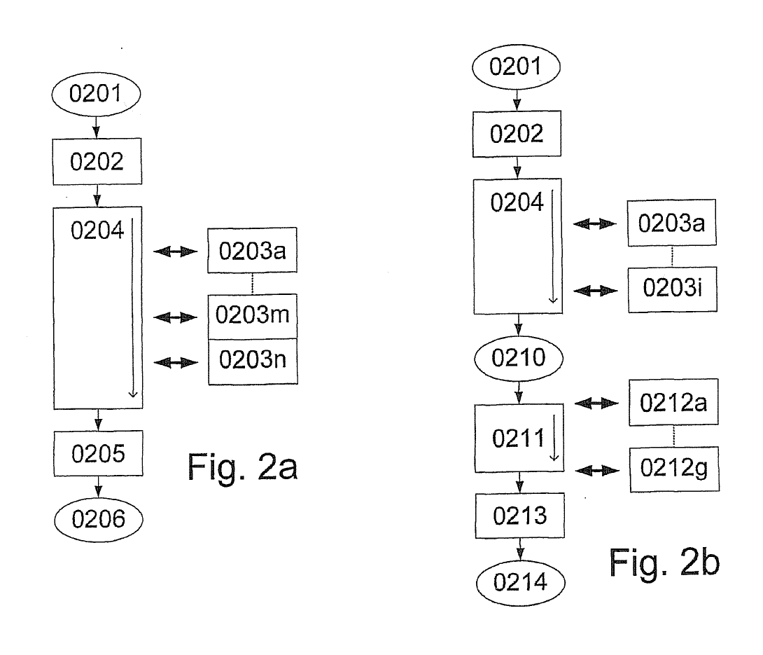

A conventional compiler layout may be represented as shown in FIG. 2a. As shown, 0201 refers to the high-level language source code, for example C-code. 0202 represents the frontend, 0204 the intermediate format, 0205 the backend, and 0206 the binary data provided by the backend. 0203a to 0203n may be the optimizers or transformer, which may be required for the optimization of the intermediate format, and which may be implemented in hardware and/or typically software, and insofar may represent certain process steps.

In FIG. 2b essentially the same units or steps are described as in FIG. 2a, now however subject to an exemplary embodiment of the present invention. The finally released binary code, which may be recorded in a library or related, is designated in FIG. 2b as 0214. The backend is designated as 0213. The generation of the precompilation may be accomplished in 0204 after a run-through of the upper-level language code or of a binary code 0201 prepared for a sequential processor or co-processor by means of a front end 0202 in the stage 0204, whereby the different optimizations 0203a to 0203i that were already mentioned may be executed. The generated and provided precompilation 0210 may be fed as object code into an intermediate stage 0211 which in turn may have access to specific data regarding those chips on which the program parts, modules, etc. are to be actually run later on. Chip-specific optimizations 0212a to 0212g may be implemented. The fact that the precompilation is available, manageable, and transmittable may therefore be advantageous.

It should be mentioned that the execution of the chip-specific or component-specific optimization may typically take place significantly later and/or on a different computer system than the precompilation generation. In particular, the postcompilation may take place through the target architecture itself. This in itself may respectively be considered advantageous. It should however be pointed out that, as the case may be, the same computer system may also be used, for example, because an existing high-level language program after precompilation is to be translated by a software manufacturer for a plurality of different computer components.

The post-compiler 0211 may feed the postcompilation to the back end 0213 that may generate a chip-specific binary. It should be pointed out that, as the case may be, a single binary may encompass a plurality of partial binaries for specific chips, whereby during loading of such a binary that is deposited in a library, the corresponding partial binary may be selected from the binary that was assembled in such a manner. Alternatively, it may be possible to store binaries in a library that, while they execute the same program parts or functions, may nevertheless be compiled for different machines or chips and typically may also run only and exclusively on these or at least run only performance-oriented on them.

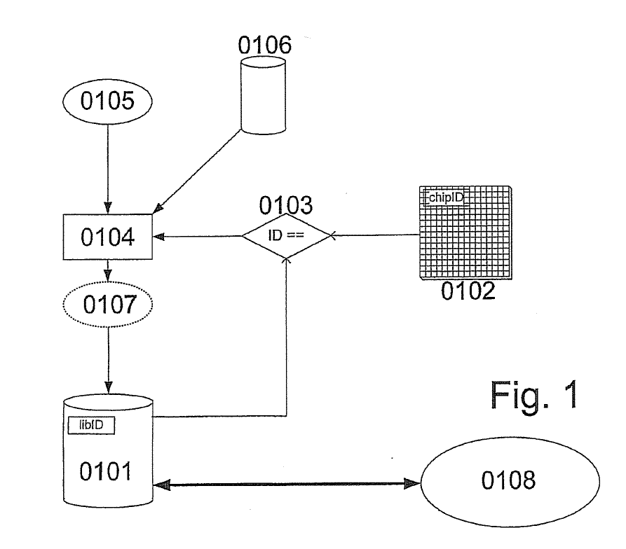

FIG. 1 shows then how a given object code 0105 may be post-compiled in the (local) translator/post-compiler 0104 subject to consideration of chip-specific information from a data bank 0106 or a chip, in a particular a chip-ID, compare 0102, extraction 0103, in order to generate binaries in a backend 0107 which may then be deposited in a library 0101 in order to be instantiated after linking with a program 0108.

In the context of the desired instantiation of a program or program part, one may then test whether an element or module that is present in the library features a chip-ID or similar object that matches the chip-ID of the chip that is presently to be loaded with the program or program part. If this is the case, the program part may be loaded. If this is not the case the object code may be post-compiled for the target architecture that is actually present. This may, given sufficiently high performance of the target architecture and/or other data processing processors present in the system, also happen in a manner that may be transparent to the user, such as during a loading process in real-time; in that case, the object code, meaning the precompilation, may be stored along in a manner that makes access possible.

1. Method for compiling of higher-language code for varying architectures and/or building blocks, characterized in that an architecture-specific pre-compilate is generated from the higher-language code and subsequently the architecture-specific pre-compilate is compiled subject to consideration of building block-specific information.
